(19) United States
(12) Patent Application Publication
(10) Pub. No.: US 2026/0159072 A1
(43) Pub. Date: Jun. 11, 2026

(54) VEHICLE CONTROL METHOD AND VEHICLE CONTROL APPARATUS

(71) Applicant: Panasonic Automotive Systems Co., Ltd., Kanagawa (JP)

(72) Inventors: Daisuke KUBO, Tokyo To (JP); Akihito MURAI, Kanagawa Ken (JP); Hirofumi NISHIMURA, Kanagawa Ken (JP)

(73) Assignee: Panasonic Automotive Systems Co., Ltd., Kanagawa (JP)

(21) Appl. No.: 19/403,632

(22) Filed: Nov. 28, 2025

(30) Foreign Application Priority Data
Dec. 9, 2024 (JP) 2024-214278

(51) Int. Cl. B60W 30/06; B60W 10/18; B60W 10/20; B60W 50/14

(52) U.S. Cl. CPC B60W 30/06; B60W 10/18; B60W 10/20; B60W 50/14; B60W 2050/146; B60W 2420/403; B60W 2540/16

(57) ABSTRACT

A vehicle control method includes: causing the display device to display a stop position in a reciprocating positional adjustment operation overlaid on a surrounding video acquired by a camera in a case where at least a part of ae vehicle is located inside a parking space and an operation device receives an instruction for re-parking; the vehicle moving forward toward the stop position; causing the display device to display an indication prompting reverse movement in a case where the parking space is detected as a detected parking space under a predetermined condition based on the surrounding video acquired by the camera before the vehicle reaches the stop position; and subsequently, controlling at least acceleration/deceleration and steering to reverse the vehicle to park the vehicle in the detected parking space by autonomous traveling in a case where the operation device receives an instruction for reverse movement.

### CROSS-REFERENCE TO RELATED APPLICATIONS

This application is based upon and claims the benefit of priority from Japanese Patent Application No. 2024-214278, filed on December 9, 2024, the entire contents of which are incorporated herein by reference.

### FIELD

The present disclosure relates to a vehicle control method and a vehicle control apparatus.

### BACKGROUND

Generally, residential parking spaces are often narrow, making parking difficult, and thus there is a high demand for performing parking and pulling out of a parking space by autonomous traveling.

A vehicle control apparatus that implements this type of autonomous traveling is known. For example, in parking a vehicle in a parking space, the vehicle is moved forward past the parking space and stopped, and then the vehicle is reversed from that stop position to park in the parking space.

Related technologies are described in Japanese Unexamined Patent Publication No 2012-066709, and Japanese Unexamined Patent Publication No 2022-069161.

Nevertheless, there are cases where, after parking is completed, the occupant may desire to re-park the vehicle due to misalignment or the like of the vehicle. However, in conventional techniques, assistance for such re-parking has not been sufficiently provided, making it difficult to perform appropriate parking assistance.

### SUMMARY

A vehicle control method according to the present disclosure is executed by a vehicle control apparatus mounted on a vehicle. The vehicle includes an operation device, a camera, a display device, and a movement control device. The operation device is configured to receive an operation by an occupant. The camera is configured to acquire a surrounding video. The display device is viewable to the occupant. The movement control device is configured to control at least acceleration/deceleration and steering. The vehicle control method includes: causing the display device to display a stop position in a reciprocating positional adjustment operation overlaid on the surrounding video acquired by the camera in a case where at least a part of the vehicle is located inside a parking space and the operation device receives an instruction for re-parking; the vehicle moving forward toward the stop position in the reciprocating positional adjustment operation; causing the display device to display an indication prompting reverse movement in a case where the parking space is detected as a detected parking space under a predetermined condition based on the surrounding video acquired by the camera before the vehicle reaches the stop position in the reciprocating positional adjustment operation; and subsequently, controlling at least acceleration/deceleration and steering to reverse the vehicle to park the vehicle in the detected parking space by autonomous traveling in a case where the operation device receives an instruction for reverse movement.

### BRIEF DESCRIPTION OF THE DRAWINGS

FIG. 1 is a block diagram illustrating an example of an overall configuration of a vehicle;

FIG. 2 is a diagram illustrated to describe an exemplary arrangement of a sensor and a camera;

FIG. 3 is a schematic diagram illustrating an exemplary exterior configuration of a vehicle;

FIG. 4 is a diagram illustrating an exemplary configuration near a driver's seat of a vehicle;

FIG. 5 is a diagram illustrated to describe an example of parking assistance;

FIG. 6 is a schematic diagram illustrating an example of a display screen;

FIG. 7 is a diagram illustrated to describe an example of a stop position in a reciprocating positional adjustment operation;

FIG. 8A is a diagram illustrated to describe an example of a display of a stop position in a reciprocating positional adjustment operation;

FIG. 8B is a diagram illustrated to describe an example of a display of a stop position in a reciprocating positional adjustment operation;

FIG. 8C is a diagram illustrated to describe an example of a display of a stop position in a reciprocating positional adjustment operation;

FIG. 8D is a diagram illustrated to describe an example of a display of a stop position in a reciprocating positional adjustment operation;

FIG. 9A is a diagram illustrated to describe an example of detection of a detected parking space;

FIG. 9B is a diagram illustrated to describe an example of detection of a detected parking space;

FIG. 9C is a diagram illustrated to describe an example of detection of a detected parking space;

FIG. 9D is a diagram illustrated to describe an example of detection of a detected parking space;

FIG. 10 is a schematic diagram illustrating an example of a display screen;

FIG. 11 is a schematic diagram illustrating an example of a state of a vehicle;

FIG. 12 is a flowchart illustrating an example of the flow of information processing executed by a control unit; and

FIG. 13 is a block diagram illustrating an exemplary hardware configuration of a vehicle control apparatus.

### DETAILED DESCRIPTION

Embodiments of a vehicle control method and a vehicle control apparatus according to the present disclosure are now described with reference to the drawings. Note that in the following description of the embodiments, the same reference numerals are assigned to the same parts, and redundant descriptions are omitted.

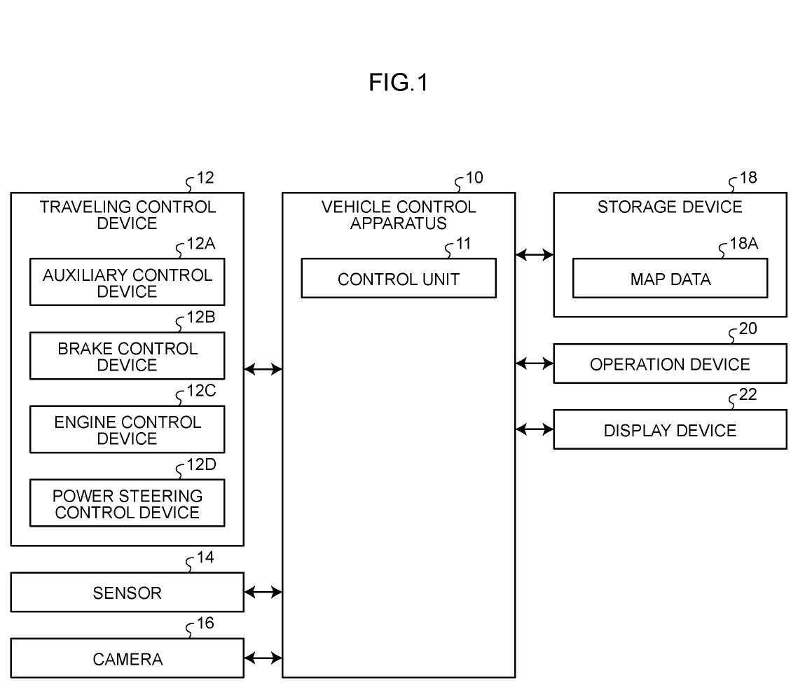

FIG. 1 is a block diagram illustrating an example of the overall configuration of a vehicle 1.

The vehicle 1 includes a vehicle control apparatus 10, a movement control device 12, a sensor 14, a camera 16, a storage device 18, an operation device 20, and a display device 22.

The movement control device 12, the sensor 14, the camera 16, the storage device 18, the operation device 20, and the display device 22 are connected to the vehicle control apparatus 10 so that data or signals are transmittable and receivable therebetween. In other words, the vehicle control apparatus 10 is configured to be communicatively connected at least to the operation device 20, the camera 16, the display device 22, and the movement control device 12.

The movement control device 12 controls at least acceleration/deceleration and steering of the vehicle 1. The movement control device 12 serves as a unit configured to implement the driving, braking, and turning motions used in traveling of the vehicle 1. For example, the movement control device 12 includes a drive motor, a power transmission mechanism, a brake device, a steering device, or the like, as well as an electronic vehicle control apparatus that controls the components. The movement control device 12 causes the vehicle 1 to travel by, for example, generating power with a drive motor and transmitting the power to wheels via a power transmission mechanism. Examples of the power transmission mechanism include a propeller shaft, a differential gear, a drive shaft, or the like.

The control of at least steering refers to the fact that the movement control device 12 controls at least one of the driving, braking, and turning motions associated with traveling of the vehicle 1. Specifically, controlling steering refers to the fact that the movement control device 12 controls at least one of a turning direction by steering operation, vehicle speed or acceleration via accelerator operation, and deceleration or stopping by brake operation. Controlling at least acceleration/deceleration means that the movement control device 12 controls at least one of the acceleration and deceleration of the vehicle 1.

The movement control device 12 specifically includes an auxiliary control device 12A, a brake control device 12B, an engine control device 12C, and a power steering control device 12D. The brake control device 12B, the engine control device 12C, and the power steering control device 12D can be collectively referred to as an actuator control unit that controls the operation of the vehicle 1.

The auxiliary control device 12A is a control device that monitors a transmission state of a vehicle control apparatus 10B and operates to execute appropriate degraded control as a backup in the event of a failure of the vehicle control apparatus 10B. Moreover, even in a case where the vehicle control apparatus 10B fails, if safety can be ensured by incorporating a degraded control function within the vehicle control apparatus 10B, the degraded control may be unnecessary.

The brake control device 12B is a control device that performs brake control (braking force control) of the vehicle 1. For example, the brake control device 12B performs brake control of the vehicle 1 in response to enhancement (depression) and release of operation of a brake pedal (brake operation unit) by the occupant. The brake control device 12B also performs brake control in accordance with a surrounding video V during autonomous traveling.

The engine control device 12C is a control device that controls an engine that generates the driving force for the vehicle 1. The power steering control device 12D is a control device that controls the power steering of the vehicle 1.

The sensor 14 is mounted on the vehicle 1 and acquires at least an external situation of the vehicle 1. Specifically, the sensor 14 is various types of sensors that detect a traveling state of the vehicle 1 and an external situation of the vehicle 1. The sensors 14 include, for example, an accelerator opening sensor that detects accelerator opening, a steering-angle sensor that detects a steering angle of a steering device, an acceleration sensor that detects acceleration acting in a longitudinal direction of the vehicle 1, a torque sensor that detects torque acting on a power transmission mechanism between a wheel of the vehicle 1 and a drive motor, a vehicle-speed sensor that detects a vehicle speed of the vehicle 1, and a wheel-speed sensor, and the like. The sensor 14 may also include a light detection and ranging (LiDAR), radar, an ultrasonic sensor, and the like. The sensor 14 outputs sensor information obtained by detection to the vehicle control apparatus 10.

The camera 16 is mounted on the vehicle 1 and serves as a surrounding sensor that monitors the environment surrounding the vehicle 1. The camera 16 includes an image sensor. In the present embodiment, the camera 16 captures surroundings of the vehicle 1 and outputs the surrounding video data obtained by the capturing to the vehicle control apparatus 10. The surrounding video data is composed of a plurality of captured image data items captured in a time series around the vehicle 1. Hereinafter, the surrounding video data may be simply referred to as a surrounding video. Additionally, in the present embodiment, the camera 16 is also applicable to detection of an object existing around the vehicle 1 and estimation of a position of the vehicle 1 from a positional relationship between the vehicle 1 and the object existing around the vehicle 1.

The camera 16 is adjusted in position, number of installations, and capturing direction in advance so as to be capable of capturing the surroundings of the vehicle 1. For example, the vehicle 1 may be provided with four cameras 16 arranged to capture images in four directions of front, rear, left, and right directions of the vehicle 1. Moreover, the number of cameras 16 provided on the vehicle 1 is not limited to four.

The storage device 18 stores various types of data. In the present embodiment, data such as map data 18A is stored in the storage device 18. The map data 18A is data that symbolizes and represents a part or the whole of situations in a real space. For example, map data used in a navigation system is stored in advance as the map data 18A in the storage device 18.

The storage device 18 is, for example, an auxiliary storage device such as a hard disk drive (HDD), solid-state drive (SSD), or flash memory. Moreover, at least a part of the data included in the storage device 18 may be stored in an external storage device such as a server device, which is provided outside the vehicle 1 and communicatively connected to the vehicle control apparatus 10.

The operation device 20 receives an operation by an occupant of the vehicle 1. The operation device 20 includes an operation mechanism relating to driving operation such as a steering operation unit like a steering wheel, a shift lever (forward/reverse movement operation unit) for shifting a transmission, an accelerator pedal, a brake pedal (brake operation unit), a turn-signal lever, and a push switch, as well as an input device such as a keyboard, a touch panel, and a switch. The steering angle of a steering device is adjusted in response to an operation of a steering operation unit by the occupant.

The shift lever (forward/reverse movement operation unit) switches between at least forward movement and reverse movement of the vehicle 1. The brake pedal (brake operation unit) is an operating unit for a brake that reduces a speed of the vehicle 1. The operation device 20 may constitute a part of a human machine interface (HMI) or an in-vehicle infotainment (IVI).

The display device 22 is a display that outputs various types of images. The display device 22 is installed at a position where it can be visually recognized by an occupant of the vehicle 1. Examples of the display include a liquid crystal display (LCD), an organic electro-luminescence (EL) display, a projector, and the like. The display device 22 may also be a touch panel display integrally configured with the operation device 20. The display device 22 is an example of at least one of an HMI and an IVI.

Moreover, the display device 22 is not limited to being provided with only a single display area. For example, the display device 22 may include a plurality of display areas.

Further, the vehicle 1 may include a plurality of display devices 22. For example, the display device 22 may include a first display unit and a second display unit, which output various types of images. The first display unit and the second display unit are separate display devices 22. The first display unit and the second display unit may be disposed at different positions in the vehicle 1. For example, the first display unit may function as an IVI, and the second display unit may function as a part of an instrument panel of the vehicle 1.

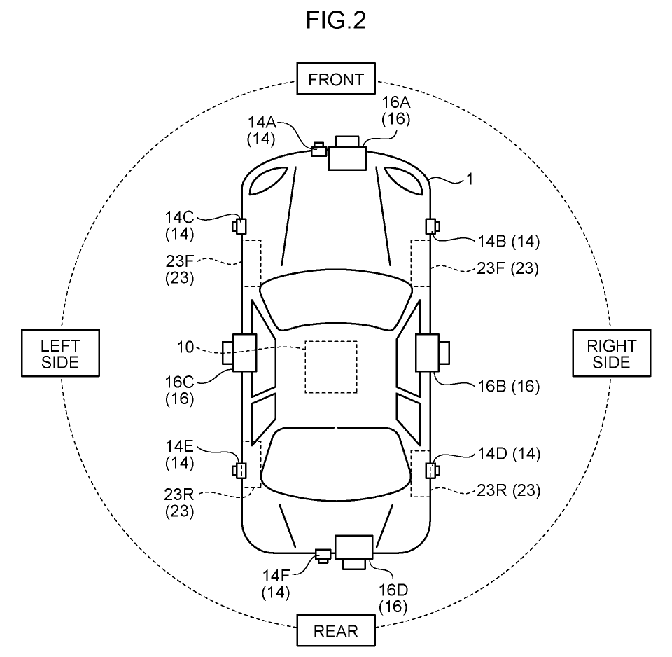

FIG. 2 is a diagram illustrated to describe an exemplary arrangement of the sensor 14 and the camera 16.

The vehicle 1 is provided with, for example, four cameras 16 (cameras 16A to 16D) so as to be capable of acquiring an external situation of the vehicle 1 in at least four directions of, for example, front, rear, right side, and left side of the vehicle 1.

Specifically, the cameras 16 include, for example, cameras 16A, 16B, 16C, and 16D. The camera 16A is disposed at a front portion of the vehicle 1 and captures the front of the vehicle 1. The camera 16A may be referred to as a front camera. The camera 16B is disposed at a right side portion of the vehicle 1 and captures the right side of the vehicle 1. The camera 16C is disposed at a left side portion of the vehicle 1 and captures the left side of the vehicle 1. The camera 16D is disposed at a rear portion of the vehicle 1 and captures the rear of the vehicle 1. The camera 16D may be referred to as a rear camera or a back camera.

A control unit 11 of the vehicle control apparatus 10, described later, may use, among the plurality of cameras 16 provided in the vehicle 1, in particular, surrounding video data captured by the rear camera, i.e., the camera 16D, for detection of a parking space described later. Details of the surrounding video data, the parking space, or the like will be described later.

Moreover, the number of cameras 16 provided on the vehicle 1 is not limited to four. Additionally, it is also preferable that sensors included in the sensor 14, such as LiDAR, radar, sonar, and ultrasonic sensors for detecting objects, be pre-adjusted in arrangement positions and numbers so as to be capable of acquiring external situations of the right side, left side, front, and rear of the vehicle 1. For example, as illustrated in FIG. 2, the sensor 14 includes sensors 14A to 14F. These sensors 14A to 14F are arranged in the vehicle 1 so as to be capable of acquiring external situations of the right side, left side, front, and rear of the vehicle 1. Moreover, the sensors 14 for detecting objects, such as LiDAR, radar, sonar, and ultrasonic sensors, may be disposed only in the rear portion of the vehicle 1.

The configuration of the vehicle 1 is now described.

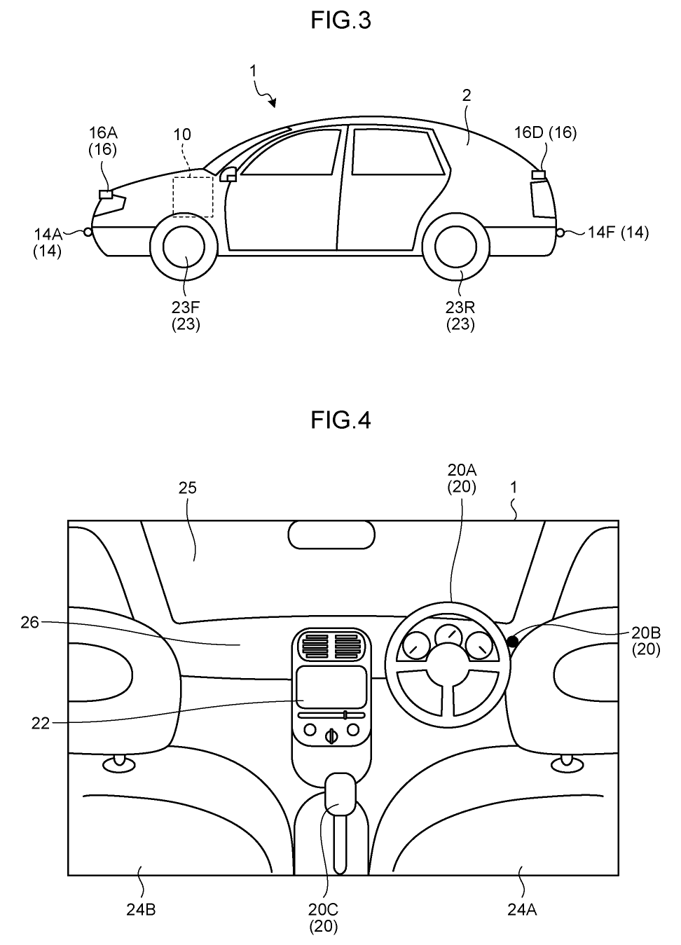

FIG. 3 is a schematic diagram illustrating an exemplary exterior configuration of the vehicle 1.

The vehicle 1 includes a vehicle body2 and two pairs of wheels 23 arranged in a predetermined direction on the vehicle body 2. The two pairs of wheels 23 include a pair of front tires 23F and a pair of rear tires 23R (see also FIG. 2). Moreover, in FIGS. 2 and 3, a case where the vehicle 1 includes four wheels 23 is illustrated as an example. However, the number of the wheels 23 provided in the vehicle 1 is not limited to four.

The configuration near the driver's seat of the vehicle 1 in the present embodiment is now described.

FIG. 4 is a diagram illustrating an exemplary configuration near a driver's seat 24A of the vehicle 1 in the present embodiment.

The vehicle 1 includes the driver's seat 24A and a passenger seat 24B. In front of the driver's seat 24A, a windshield 25, a dashboard 26, a steering wheel (steering operation unit) 20A, operation buttons 20B, and the display device 22 are provided. In addition, a shift lever 20C, which is a lever for shifting gears in the transmission, is provided near the driver's seat 24A.

The steering wheel 20A, the operation button 20B, and the shift lever 20C are examples of the operation device 20.

The steering wheel 20A is provided in front of the driver's seat 24A and is operable by an occupant. The rotation angle of the steering wheel 20A, that is, the steering angle, is electrically or mechanically linked to a change in a direction of the front tires 23F, which are the steerable wheels. Moreover, the steerable wheels may be the rear tires 23R, or both the front tires 23F and the rear tires 23R may be steerable wheels.

The operation button 20B is a button that can receiving an operation by the occupant. In addition, the operation button 20B may include a direction indicator. The location of the operation button 20B is not limited to the example illustrated in FIG. 4 and may, for example, be provided on the steering wheel 20A. Although one operation button 20B is illustrated in FIG. 4, a plurality of operation buttons 20B may be provided. In a case where the display device 22 also serves as a touch panel, the display device 22 may be an example of the operation device 20.

Referring back to FIG. 1, the description will be continued.

The vehicle control apparatus 10 is an electronic control unit that integrally controls respective components of the vehicle 1.

The vehicle control apparatus 10 controls the movement control device 12 so that a traveling state of the vehicle 1 becomes optimal by using sensor information and surrounding video received respectively from the sensor 14 and the camera 16. In addition, the vehicle control apparatus 10 also controls the movement control device 12 to cause the vehicle 1 to autonomously travel.

The vehicle control apparatus 10 includes the control unit 11. At least a part or the whole of the control unit 11 may be implemented as a software configuration achieved by cooperation of a processor and various programs stored in a memory. In addition, at least a part or the whole of the control unit 11 may also be implemented as a hardware configuration achieved by a dedicated circuit or the like.

The control unit 11 integrally controls respective components of the vehicle 1.

In the present embodiment, the control unit 11 executes information processing for parking assistance for the vehicle 1.

In the present embodiment, description is given on the assumption of a form in which the occupant moves the vehicle 1 forward until at least a part of a parking space is passed by at least a part of a vehicle body 2 of the vehicle 1, then stops the vehicle 1 by driving operation of the occupant, and from that stop position reverses the vehicle 1 and moves, by autonomous traveling, into the parking space.

The vehicle control apparatus 10 according to the present embodiment supports re-parking of the vehicle 1 that is parked in a parking space. The re-parking refers to parking again a vehicle 1 once parked, and re-entering the vehicle 1 into the parking space.

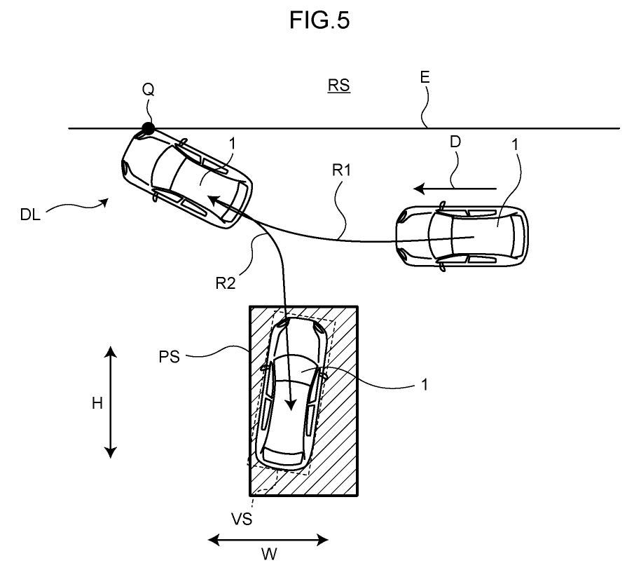

FIG. 5 is a diagram illustrated to describe an example of parking assistance in the present embodiment. FIG. 5 illustrates a scene in which the vehicle 1 is parked in the parking space PS.

The parking space PS is a space in which the vehicle 1 can be parked. The parking space PS may be any region that includes a position where the vehicle 1 can be parked, and its shape and size are not limited.

For example, the parking space PS is a region having a size, shape, and inclination such that, when the vehicle 1 is parked at a recommended position and attitude within the region represented by the parking space PS, the vehicle 1 fits within the region represented by the parking space PS. The parking space PS is, for example, a substantially rectangular region that surrounds the outside of the vehicle 1 by four sides that are separated by a predetermined interval from the vehicle body 2 of the vehicle 1. In the present embodiment, a form in which the parking space PS is a rectangular region is described as an example.

The parking of the vehicle 1 into the parking space PS may be at least partially performed by autonomous traveling of the vehicle 1. Alternatively, the parking of the vehicle 1 into the parking space PS may be at least partially performed by a driving operation of the occupant.

The vehicle 1 moves forward by the driving of the occupant (see the direction of arrow D and the route R1 in FIG. 5).

The control unit 11 causes the display device 22 to display the surrounding video acquired by the camera 16 during forward movement of the vehicle 1 by the operation of the occupant received by the operation device 20. Moreover, during autonomous traveling as well, the control unit 11 causes the display device 22 to display the surrounding video acquired by the camera 16. Moreover, in the technology disclosed herein, as a rule, real-time surrounding video is displayed on the display device 22. In other words, in the present embodiment, in the case where the display device 22 is caused to display the surrounding video, the real-time surrounding video is displayed on the display device 22.

The control unit 11 identifies, as the parking space PS, a space, among the spaces in which the vehicle 1 can be parked included in the surrounding video acquired by the camera 16, which is estimated to be able to park in one stroke by autonomous driving through reverse movement after the vehicle 1 passes the space, moves forward and stops, in relation to the current position of the vehicle 1, during forward movement of the vehicle 1 by the driving of the occupant (refer to the direction of arrow D and route R1 in FIG. 5). The parking in one stroke by autonomous traveling refers to parking by autonomous traveling only through reverse movement without performing steering for reciprocating positional adjustment operation of the vehicle 1 from the stop position to the parking space PS. The reciprocating positional adjustment operation means an operation of once moving the vehicle 1 forward and then moving the vehicle back again while performing steering to adjust a position of the vehicle 1 when moving the vehicle 1 back toward the parking space, or an operation of once moving the vehicle 1 back and then moving the vehicle forward again while performing steering to adjust a position of the vehicle 1 when moving the vehicle 1 forward toward the parking space.

Then, the control unit 11 generates a reverse movement route R2 from the stop position to the parking space PS, in a case where the vehicle 1 moves forward and then stops, the forward/reverse movement operation unit (shift lever 20C) of the operation device 20 receives a reverse movement instruction operation, and the brake operation unit (brake pedal) of the operation device 20 receives the release of the brake operation. Then, the control unit 11 controls at least steering to reverse the vehicle 1 from the stop position to the parking space PS to park the vehicle 1 in the parking space PS by autonomous traveling.

Further, as described above, the parking of the vehicle 1 into the parking space PS may be at least partially performed by the driving of the occupant. Thus, the vehicle 1 may be parked from the stop position to the parking space PS by the driving of the occupant.

In a case where at least a part of the vehicle 1 is located inside the parking space PS and the operation device 20 receives an instruction for re-parking, the control unit 11 causes the display device 22 to display the stop position in the reciprocating positional adjustment operation overlaid on the surrounding video acquired by the camera 16.

Specifically, the control unit 11 determines whether parking is completed. For example, the control unit 11 determines that parking in the parking space PS is completed in the case where it determines that at least a part of the vehicle 1 is located inside the parking space PS by analyzing the surrounding video acquired by the camera 16 and sensor information acquired by the sensor 14. Further, the control unit 11 may determine that parking in the parking space PS is completed in the case where it determines that at least a part of the vehicle 1 is located inside the parking space PS and determines the stopping of the vehicle 1 due to the enhancement (depression) or the like of the operation of the brake pedal (brake operation unit) by the occupant. In addition, the control unit 11 may determine that parking in the parking space PS is completed in the case where it determines that at least a part of the vehicle 1 is located inside the parking space PS, determines the stopping of the vehicle 1 due to the enhancement (depression) or the like of the operation of the brake pedal (brake operation unit) by the occupant, and the shift is changed to parking by an operation or the like of the shift lever 20C included in the operation device 20 by the occupant.

Then, in the case where the control unit 11 determines the completion of parking of the vehicle 1 into the parking space PS, the control unit 11 determines whether the deviation between the parking space PS and a vehicle space VS is greater than or equal to a predetermined deviation.

The vehicle space VS is a region occupied by the vehicle 1 in the real space RS. The vehicle space VS is, for example, a region obtained by orthographic projection of the vehicle 1 onto the ground. In the present embodiment, a form in which the vehicle space VS is a rectangular region composed of four sides surrounding the outline of the region obtained by orthographic projection of the vehicle 1 onto the ground such that at least a part is in contact with the outline, will be described.

The control unit 11 calculates at least one of a positional deviation and an angular deviation between the parking space PS, where the vehicle 1 is located, and the vehicle space VS of the vehicle 1, using the surrounding video acquired by the camera 16 and the like.

For example, a case is assumed where the outer frame of the parking space PS is rectangular having four sides composed of two opposing sides parallel to a first extension direction (refer to the direction of arrow H in FIG. 5), and two opposing sides parallel to a second extension direction (refer to the direction of arrow W in FIG. 5) that intersects the first extension direction. In addition, a case is assumed where the two opposing sides parallel to the first extension direction (hereinafter referred to as first extension direction H) that constitute the outer frame of the parking space PS are longer than the two opposing sides parallel to the second extension direction (hereinafter referred to as second extension direction W) that constitute the outer frame of the parking space PS.

In this case, the control unit 11 determines whether the deviation between the parking space PS and the vehicle space VS is greater than or equal to a predetermined deviation by determining whether at least one of the following is satisfied: a deviation between the center position of the parking space PS in the first extension direction H and the center position of the vehicle space VS in the first extension direction H is greater than or equal to a first predetermined value, a deviation between the center position of the parking space PS in the second extension direction W and the center position of the vehicle space VS in the second extension direction W is greater than or equal to a second predetermined value, an angular deviation between the side parallel to the first extension direction H of the parking space PS and the overall length direction of the vehicle 1 of the vehicle space VS is greater than or equal to a first predetermined angle, and an angular deviation between the side parallel to the second extension direction W of the parking space PS and the vehicle width direction of the vehicle 1 of the vehicle space VS is greater than or equal to a second predetermined angle.

In other words, the predetermined deviation is represented by at least one of the aforementioned first predetermined value, second predetermined value, first predetermined angle, and second predetermined angle. These values of the predetermined deviation may be stored in advance in the storage device 18. Further, these values of the predetermined deviation may also be changeable as appropriate in response to an operation instruction or the like by a user such as the occupant.

In a case where the parking of the vehicle 1 into the parking space PS is completed and the deviation between the parking space PS and the vehicle space VS is greater than or equal to the predetermined deviation, the control unit 11 causes the display device 22 to display an indication representing a suggestion for re-parking overlaid on the surrounding video V.

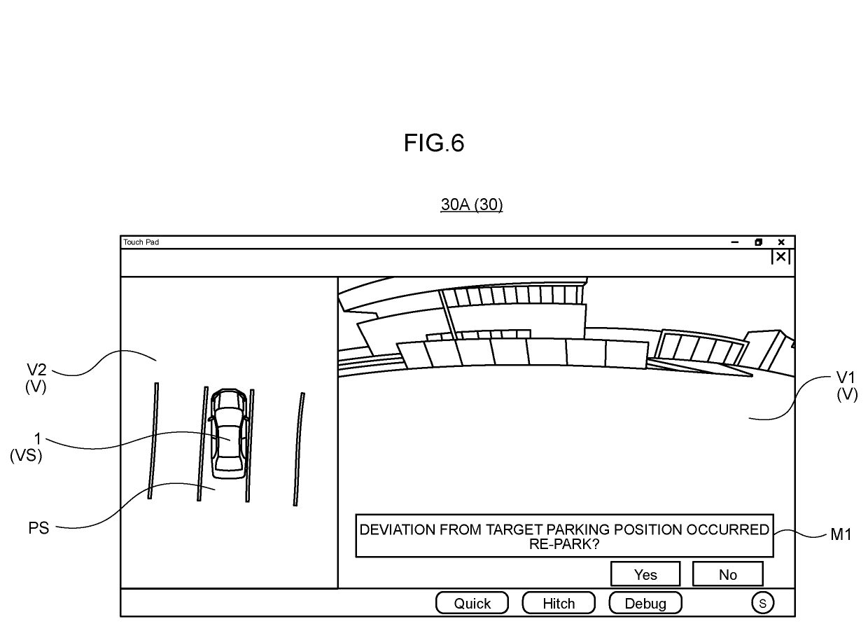

FIG. 6 is a schematic diagram of an example of a display screen 30A. The display screen 30A is an example of a display screen 30 displayed on the display device 22.

In a case where the parking of the vehicle 1 into the parking space PS is completed and the deviation between the parking space PS and the vehicle space VS is greater than or equal to the predetermined deviation, the control unit 11 causes the display device 22 to display an indication M1 representing a suggestion for re-parking overlaid on the surrounding video V.

The display screen 30A includes the indication M1. The indication M1 is a display representing a suggestion or offer for re-parking. FIG. 6 illustrates, as an example, a form in which the indication M1 is wording prompting the suggestion for re-parking. The indication M1 is not limited to wording, and may be a still image, an animation image, or an icon, or the like representing the suggestion for re-parking.

Further, the display screen 30A may further include the surrounding video V captured by the camera 16. FIG. 6 illustrates a form in which the display screen 30A includes a video V1 and a video V2 as the surrounding video V.

The video V1 is the surrounding video V in the traveling direction of the vehicle 1. The video V2 is a top-view image of the vehicle 1. The top view is a bird's eye image as if the vehicle 1 were looked down upon from the sky.

The display device 22 may include a plurality of display regions (such as first display region and second display region). For example, the control unit 11 may display the video V1 in one display region and display the video V2 in the other display region. Further, the vehicle 1 may include a plurality of display devices 22. Then, one of the plurality of display devices 22 may be used as the first display region and the other one may be used as the second display region.

The surrounding video V displayed on the display screen 30 may be either the video V1, which is the surrounding video V in the traveling direction of the vehicle 1, or the video V2, which is the top-view image of the vehicle 1. Further, the surrounding video V in the traveling direction of the vehicle 1 may be switched to and displayed as the surrounding video V on the side of the vehicle 1, or the surrounding video V in the direction opposite to the traveling direction, that is, anti-traveling direction surrounding video V, or the like by receiving the operation of the operation device 20 by the occupant or the like, on the display screen 30.

FIG. 6 illustrates, as an example, a form in which the video V1 and the video V2 are respectively displayed in each of the two display regions, and the indication M1 is overlaid on at least one of the videos V1 and V2.

Further, the display screen 30A may be a screen on which an icon image representing the vehicle 1 is arranged at the current position of the vehicle 1. FIG. 6 illustrates a state where the icon image representing the vehicle 1 is overlaid at the current position of the vehicle 1 in the video V2.

In a case where an instruction for re-parking by the occupant is received in response to the suggestion for re-parking represented by the indication M1, the control unit 11 causes the display device 22 to display the stop position in the reciprocating positional adjustment operation overlaid on the surrounding video V acquired by the camera 16.

When the vehicle 1 stops after moving by forward movement or reverse movement in a predetermined direction, and thereafter moves by reverse movement or forward movement in a direction opposite to the predetermined direction from its stopping position, the stop position in the reciprocating positional adjustment operation represents the stopping position. The stop position in the reciprocating positional adjustment operation overlaid and displayed on the surrounding video V when an instruction for re-parking by the occupant is received in response to the suggestion for re-parking represented by the indication M1, represents the approximate target position for the forward movement of the vehicle 1.

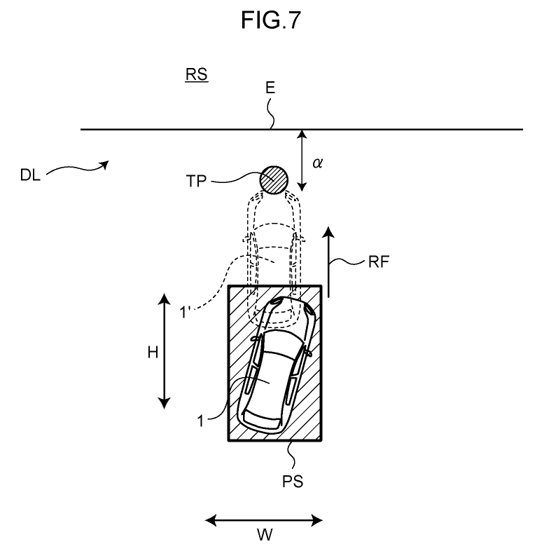

FIG. 7 is a diagram illustrated to describe an example of the stop position in the reciprocating positional adjustment operation TP. Description will also be made using FIG. 5.

As illustrated in FIG. 5, the control unit 11 identifies a traveling path DL that is adjacent to the opening side of the parking space PS of the vehicle 1 and extends in a direction intersecting the first extension direction H of the parking space PS. Then, the control unit 11 identifies a straight line E parallel to the second extension direction W that passes through a point Q furthest from the parking space PS in a passing region that the vehicle 1 traversed when the vehicle 1 traveling on the traveling path DL moves forward and passes the parking space PS and stops for parking into the parking space PS, and thereafter reverses into the parking space PS. The point Q corresponds to, for example, the position of the end portion furthest from the parking space PS in the vehicle 1 that moves forward and stops. In addition, the straight line E is a line passing through the position furthest from the parking space PS in the first extension direction H in the passage region traversed by the vehicle 1 traveling on the traveling path DL.

With reference to FIG. 7, description will be made. Then, the control unit 11 identifies, as the stop position in the reciprocating positional adjustment operation TP, a position at a distance α from the straight line E in a direction approaching the parking space PS. The distance α is, for example, an added value of the vehicle width of the vehicle 1 and a margin. The value of the margin may be set in advance. Further, the value of the margin may also be changeable as appropriate in response to an operation instruction by the occupant or the like.

The control unit 11 causes the display device 22 to display the derived stop position in the reciprocating positional adjustment operation TP overlaid on the surrounding video V.

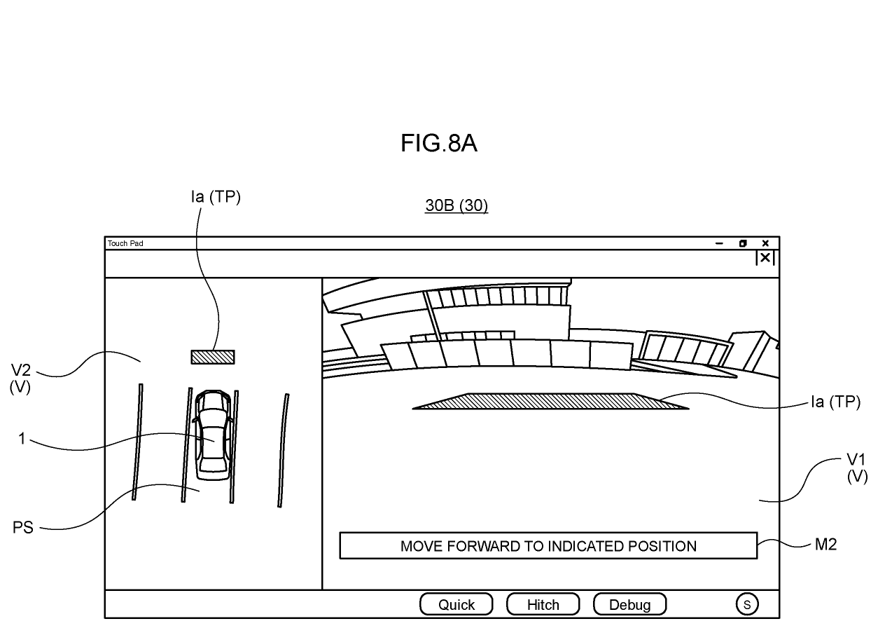

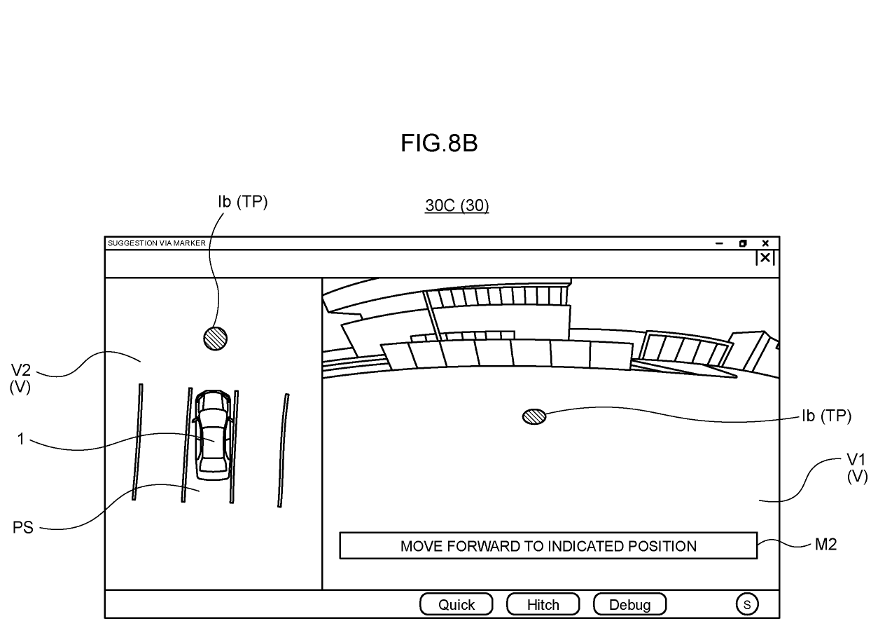

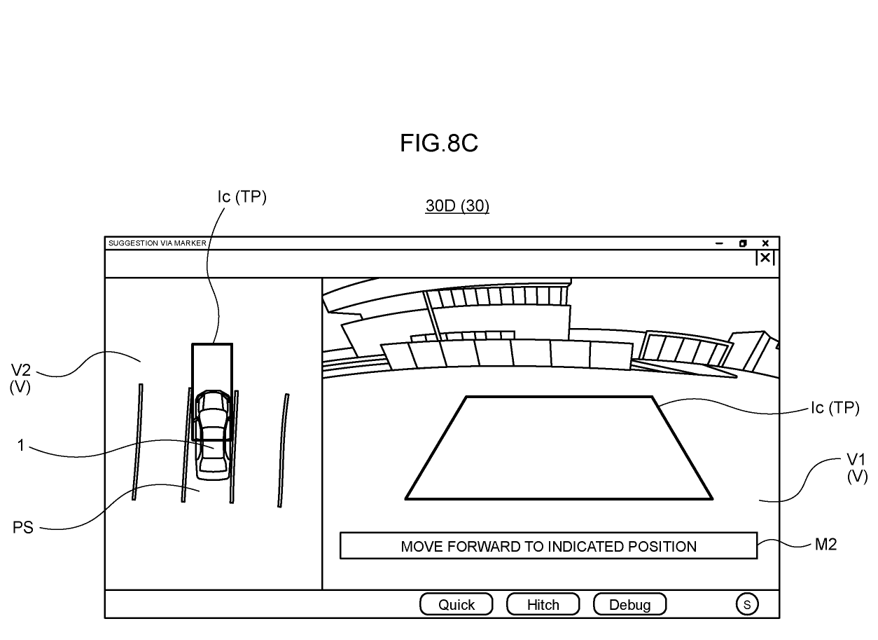

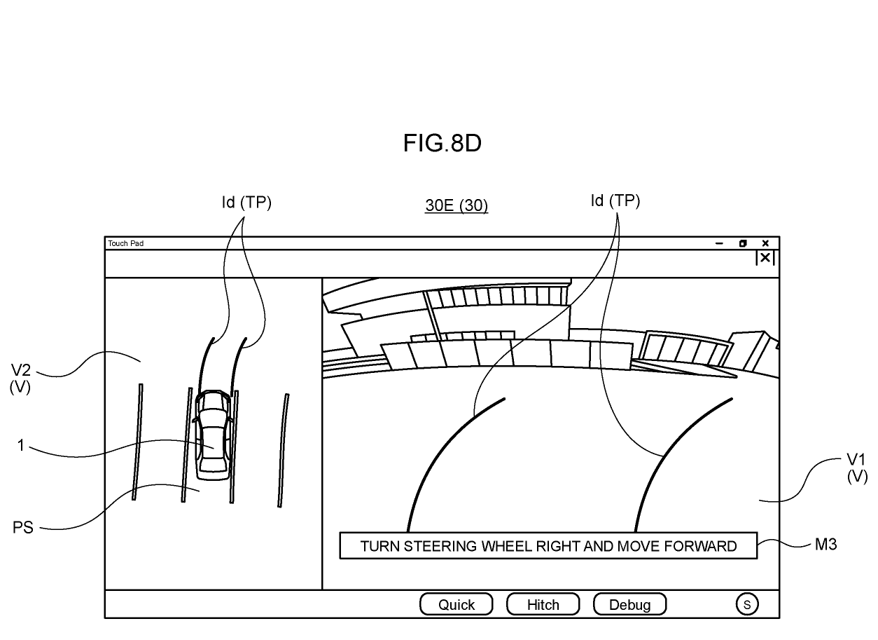

FIGS. 8A to 8D are diagrams illustrated to describe an example display of the stop position in the reciprocating positional adjustment operation TP.

FIG. 8A is a schematic diagram of an example of a display screen 30B. The display screen 30B is an example of the display screen 30 displayed on the display device 22.

In a case where an instruction for re-parking by the occupant is received in response to the suggestion for re-parking represented by the indication M1, the control unit 11 causes the display device 22 to display the stop position in the reciprocating positional adjustment operation TP overlaid on the surrounding video V acquired by the camera 16.

For example, the control unit 11 causes the display device 22 to display the display screen 30B in which the stop position in the reciprocating positional adjustment operation TP represented by a rectangular image Ia is overlaid on the surrounding video V. Further, the display screen 30B may include an indication M2. The indication M2 is a display prompting the occupant to move forward toward the stop position in the reciprocating positional adjustment operation TP. FIG. 8B illustrates, as an example, a form in which the indication M2 is wording prompting the occupant to move forward toward the stop position in the reciprocating positional adjustment operation TP. The indication M2 is not limited to wording, and may be a still image, an animation image, or an icon, or the like prompting forward movement toward the stop position in the reciprocating positional adjustment operation TP.

FIG. 8B is a schematic diagram of an example of a display screen 30C. The display screen 30C is an example of the display screen 30 displayed on the display device 22.

For example, the control unit 11 causes the display device 22 to display the display screen 30C in which the stop position in the reciprocating positional adjustment operation TP represented by a circular image Ib is overlaid on the surrounding video V. As described above, the control unit 11 may display the circular image Ib representing the stop position in the reciprocating positional adjustment operation TP overlaid on the surrounding video V. Further, similarly to the above, the display screen 30C may include the indication M2.

FIG. 8C is a schematic diagram of an example of a display screen 30D. The display screen 30D is an example of the display screen 30 displayed on the display device 22.

For example, the control unit 11 causes the display device 22 to display the display screen 30D in which the stop position in the reciprocating positional adjustment operation TP represented by an outer frame 1c of the vehicle 1, which is estimated when the vehicle 1 reaches the stop position in the reciprocating positional adjustment operation TP, is overlaid on the surrounding video V. Thus, the control unit 11 may display the outer frame Ic representing the outer shape of the vehicle 1, which is estimated when the vehicle 1 reaches the stop position in the reciprocating positional adjustment operation TP, overlaid on the surrounding video V as a display representing the stop position in the reciprocating positional adjustment operation TP. Further, similarly to the above, the display screen 30C may include the indication M2.

FIG. 8D is a schematic diagram of an example of a display screen 30E. The display screen 30E is an example of the display screen 30 displayed on the display device 22.

For example, the control unit 11 causes the display device 22 to display the display screen 30E in which the stop position in the reciprocating positional adjustment operation TP represented by a line image Id representing the direction toward the stop position in the reciprocating positional adjustment operation TP is overlaid on the surrounding video V. As described above, the control unit 11 may display the line image Id representing a route toward the stop position in the reciprocating positional adjustment operation TP, which represents the stop position in the reciprocating positional adjustment operation TP, overlaid on the surrounding video V. Further, the display screen 30E may include an indication M3. The indication M3 is a display of a steering wheel operation for moving forward toward the stop position in the reciprocating positional adjustment operation TP. FIG. 8D illustrates, as an example, a form in which the indication M3 is wording for the steering wheel operation for moving forward toward the stop position in the reciprocating positional adjustment operation TP. The indication M3 is not limited to wording, and may be a still image, an animation image, or an icon, or the like representing the steering wheel operation for moving forward toward the stop position in the reciprocating positional adjustment operation TP.

Referring back to FIG. 7, the description will be continued.

The control unit 11 causes the display device 22 to display an indication prompting reverse movement, in a case where the vehicle 1 moves forward toward the stop position in the reciprocating positional adjustment operation TP (refer to arrow RF in FIG. 7) and the control unit 11 detects the parking space PS as a detected parking space under a predetermined condition, based on the surrounding video V acquired by the camera 16, before the vehicle 1 reaches the stop position in the reciprocating positional adjustment operation TP.

Specifically, in the case where the control unit 11 displays the stop position in the reciprocating positional adjustment operation TP overlaid on the surrounding video V, the vehicle 1 moves forward toward the stop position in the reciprocating positional adjustment operation TP.

The forward movement of the vehicle 1 toward the stop position in the reciprocating positional adjustment operation TP as described above may be executed according to an operation performed on the operation device 20 by the occupant, or may be executed by causing the movement control device 12 to control at least acceleration/deceleration and steering.

In other words, the forward movement of the vehicle 1 toward the stop position in the reciprocating positional adjustment operation TP may be performed by the driving of the occupant. Alternatively, the forward movement of the vehicle 1 toward the stop position in the reciprocating positional adjustment operation TP may be performed by the control unit 11 controlling the movement control device 12 to cause the vehicle 1 to perform autonomous traveling. The control of the movement control device 12 by the control unit 11 to cause the vehicle 1 to autonomously travel may be executed by a known method.

Then, the control unit 11 detects the parking space PS as a detected parking space under predetermined condition, based on the surrounding video V acquired by the camera 16, before the vehicle 1 moves forward and reaches the stop position in the reciprocating positional adjustment operation TP.

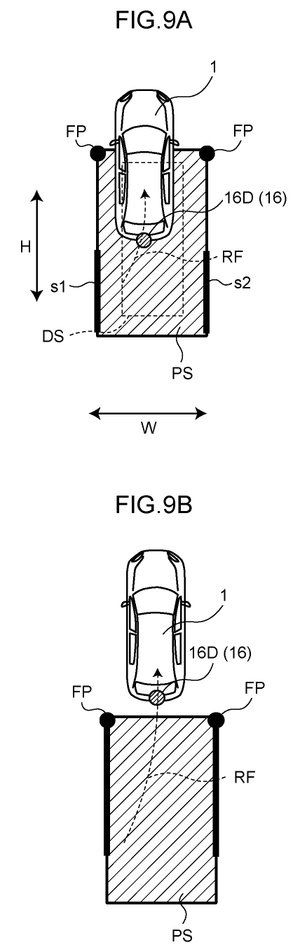

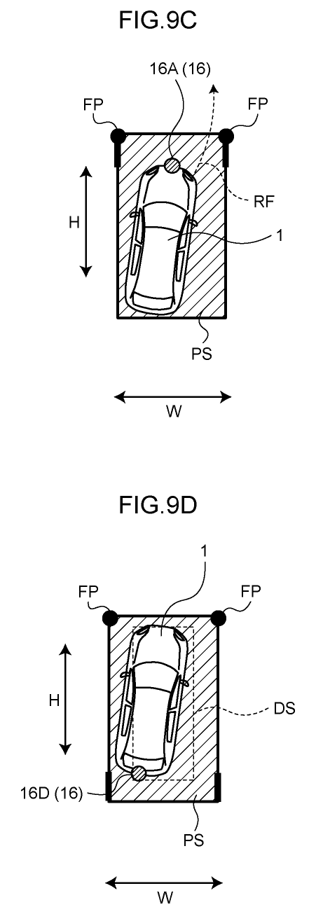

FIGS. 9A to 9D are diagrams illustrated to describe an example of detection of the detected parking space DS.

FIG. 9A illustrates, as an example, a situation in which the vehicle 1 parked in the parking space PS starts forward movement (see arrow RF).

The detected parking space DS is a region occupied by the vehicle 1 when assuming that the vehicle 1 is parked at a recommended position and recommended orientation within the parking space PS. The detected parking space DS is, for example, a rectangular region surrounding the outer frame of the vehicle 1.

Herein, from the viewpoint of safety and the like, it is unsafe for the vehicle 1 to move forward until an opening end point FP of the parking space PS appears in the surrounding video V captured by the camera 16D, which is the rear camera that captures the rear of the vehicle 1 during the forward movement of the vehicle 1 (refer to FIG. 9B).

For this reason, the control unit 11 detects the parking space PS as the detected parking space DS under a predetermined condition, based on the surrounding video V acquired by the camera 16, before the vehicle 1 moves forward and reaches the stop position in the reciprocating positional adjustment operation TP.

The predetermined condition includes a case where the control unit 11 detects at least one of a length of a first side s1 of the parking space PS and a length of a second side s2 opposite to the first side s1 to be greater than or equal to a predetermined length.

The first side s1 is one of the two sides along the first extension direction H among the four sides constituting the outer frame of the parking space PS. The second side s2 is the other of the two sides along the first extension direction H among the four sides constituting the outer frame of the parking space PS. The predetermined length may be any value less than the length of the parking space PS in the first extension direction H. Further, the predetermined length may be any length less than the length of the parking space PS in the first extension direction H, and less than or equal to the maximum length of the side that can be captured by the camera 16D, which is the rear camera, when at least a part of the vehicle 1 is located inside the parking space PS. Specifically, the predetermined length is, for example, 40 cm, but is not limited to the length mentioned above.

Further, the predetermined condition includes a case where the control unit 11 detects at least one of the length of the first side s1 of the parking space PS and the length of the second side s2 opposite to the first side s1 to be greater than or equal to a predetermined length, and a route to the detected parking space DS can be generated.

Specifically, the control unit 11 detects the detected parking space DS when it detects at least one of the length of the first side s1 of the parking space PS and the length of the second side s2 opposite to the first side s1 to be greater than or equal to the predetermined length.

The control unit 11 detects, as the detected parking space DS, a vehicle space obtained by correcting at least one of a position and an angle in the second extension direction W of the vehicle space VS (see FIG. 5) of the vehicle 1 at the previous parking, using at least one of the first side s1 and the second side s2 of the parking space PS, such that the position in the second extension direction W of the vehicle 1 after re-parking is located substantially at the center in the second extension direction W of the parking space PS.

Further, as illustrated in FIG. 9C, in a case where the opening end point FP of the parking space PS is captured in the camera 16A, which is the front camera of the vehicle 1, during the forward movement of the vehicle 1, the control unit 11 may detect, as the detected parking space DS, a vehicle space obtained by further correcting at least one of a position and an angle in the first extension direction H of the vehicle space VS (see FIG. 5) of the vehicle 1 at the previous parking such that a position in the first extension direction H of the vehicle 1 after re-parking is located substantially at the center of the parking space PS in the first extension direction H.

Further, as illustrated in FIG. 9D, the control unit 11 may detect the detected parking space DS in a similar manner to the above before the vehicle 1 parked in the parking space PS starts forward movement.

In a case where the detected parking space DS is detected, the control unit 11 generates a re-parking route for reverse movement by autonomous traveling to park into the detected parking space DS.

The control unit 11 may generate the re-parking route for autonomous traveling leading to the detected parking space DS by a known method, based on the surrounding video V or the like acquired by the camera 16.

In a case where the re-parking route for reverse movement by autonomous traveling to park into the detected parking space DS is generated, the control unit 11 causes the display device 22 to display an indication prompting reverse movement and also causes the display device 22 to display the detected parking space DS overlaid on the surrounding video V acquired by the camera 16.

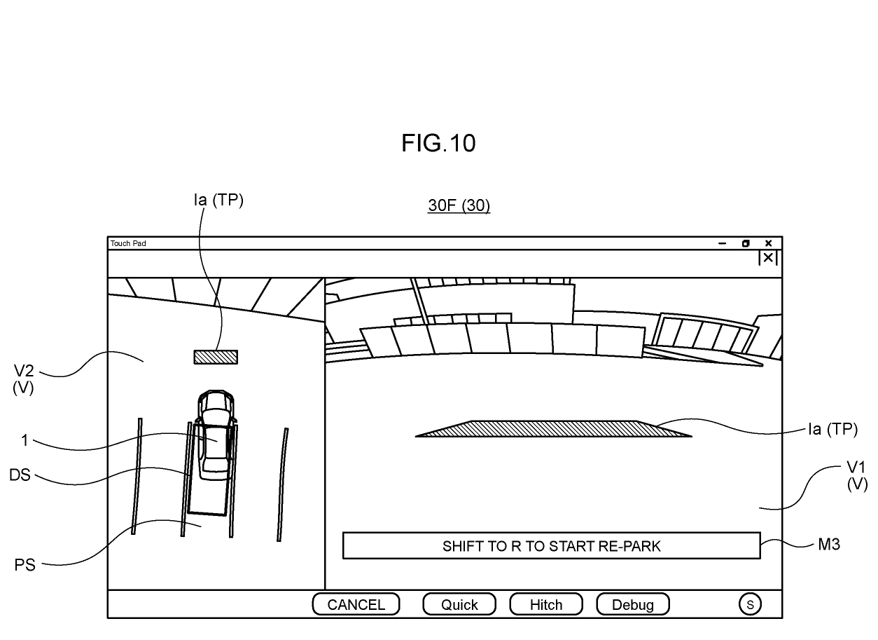

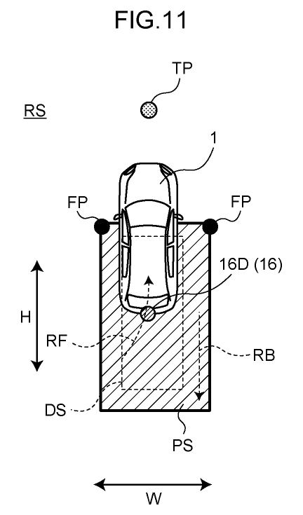

FIG. 10 is a schematic diagram of an example of a display screen 30F. The display screen 30F is an example of the display screen 30 displayed on the display device 22.

The control unit 11 causes the display device 22 to display an indication M3 prompting reverse movement, in a case where the parking space PS is detected as the detected parking space DS under the predetermined condition.

FIG. 10 illustrates, as an example, a form in which the indication M3 prompting reverse movement is wording prompting reverse movement. The indication M3 is not limited to wording, and may be a still image, an animation image, or an icon, or the like prompting reverse movement.

Further, the display screen 30F may include an image representing the detected parking space DS. In other words, in a case where the parking space PS is detected as the detected parking space DS under the predetermined condition, the control unit 11 may cause the display device 22 to display the indication M3 prompting reverse movement and also to display the detected parking space DS overlaid on the surrounding video V.

FIG. 11 is a schematic diagram illustrating an example of a state of the vehicle 1.

Through the above processing, in the case where the vehicle 1 parked in the parking space PS moves forward toward the stop position in the reciprocating positional adjustment operation TP upon receiving an instruction for re-parking (refer to arrow RF in FIG. 11), if the parking space PS is detected as the detected parking space DS under the predetermined condition, the control unit 11 of the vehicle 1 causes the display device 22 to display the indication M3 prompting reverse movement before the vehicle 1 reaches the stop position in the reciprocating positional adjustment operation TP.

Then, in the control unit 11, in the case where the operation device 20 receives an instruction for reverse movement, the control unit 11 causes the movement control device 12 to control at least acceleration/deceleration and steering to reverse the vehicle 1 (refer to arrow RB in FIG. 11) and to park the vehicle 1 in the detected parking space DS.

Specifically, in the control unit 11, in the case where the vehicle 1 parked in the parking space PS moves forward toward the stop position in the reciprocating positional adjustment operation TP upon receiving an instruction for re-parking and stops, the operation device 20 receives the instruction for reverse movement.

The stopping of the vehicle 1 after the forward movement may be either stopping control by the control unit 11 based on the surrounding video V or stopping due to the enhancement of the brake operation in the brake pedal (brake operation unit) of the operation device 20.

The enhancement of the brake operation in the brake pedal (brake operation unit) of the operation device 20 refers to enhancement in the depression amount and the depressing force of the brake pedal by the occupant. In other words, the enhancement of the brake operation in the brake pedal (brake operation unit) of the operation device 20 refers to the brake operation by the occupant for stopping the vehicle 1.

In a case where the vehicle 1 parked in the parking space PS moves forward toward the stop position in the reciprocating positional adjustment operation TP upon receiving an instruction for re-parking and stops (refer to arrow RF), and the operation device 20 receives an instruction for reverse movement, the control unit 11 controls at least acceleration/deceleration and steering to cause the vehicle 1 to reverse to park the vehicle 1 in the detected parking space DS by autonomous traveling (refer to arrow RB).

The operation device 20 receiving an instruction for reverse movement means that the shift is changed to reverse by an operation performed by the occupant on the shift lever (forward/reverse movement operation unit) for shifting the transmission. Further, the operation device 20 receiving an instruction for reverse movement may mean that the shift is changed to reverse and the shift lever (forward/reverse movement operation unit) is switched to reverse by an operation performed by the occupant on the shift lever (forward/reverse movement operation unit), and thereafter the brake operation unit (brake pedal) of the operation device 20 receives the release of the brake operation.

Then, in a case where the operation device 20 receives an instruction for reverse movement, the control unit 11 controls at least acceleration/deceleration and steering to cause the vehicle 1 to reverse to park the vehicle 1 in the detected parking space DS by autonomous traveling.

Specifically, the control unit 11 compares the current position of the vehicle 1 in the real space RS with the generated re-parking route, controls at least steering such that the current position of the vehicle 1 is a position on the re-parking route, and controls the movement control device 12 to travel along the re-parking route. During autonomous traveling, the vehicle 1 is automatically controlled for traveling by the vehicle control apparatus 10 without intervention of manual driving operation by the occupant.

An example of the flow of information processing executed by the control unit 11 of the vehicle control apparatus 10 is now described.

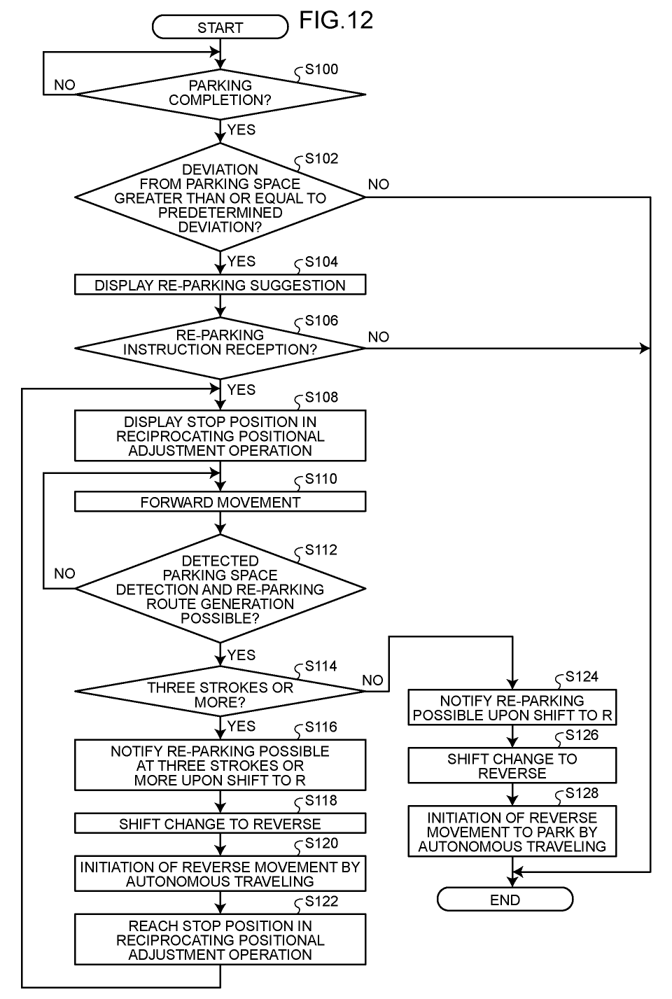

FIG. 12 is a flowchart illustrating an example of the flow of information processing executed by the control unit 11.

The control unit 11 determines whether parking of the vehicle 1 is completed (step S100). For example, the control unit 11 determines that parking in the parking space PS is completed in the case where it determines that at least a part of the vehicle 1 is located inside the parking space PS by analyzing the surrounding video acquired by the camera 16 and sensor information acquired by the sensor 14. Further, the control unit 11 may determine that parking in the parking space PS is completed in the case where it determines that at least a part of the vehicle 1 is located inside the parking space PS and determines the stopping of the vehicle 1 due to the enhancement (depression) or the like of the operation of the brake pedal (brake operation unit) by the occupant. In addition, the control unit 11 may determine that parking in the parking space PS is completed in the case where it determines that at least a part of the vehicle 1 is located inside the parking space PS, determines the stopping of the vehicle 1 due to the enhancement (depression) or the like of the operation of the brake pedal (brake operation unit) by the occupant, and the shift is changed to parking by an operation or the like of the shift lever 20C included in the operation device 20 by the occupant.

The control unit 11 repeats a negative determination (step S100: No) until an affirmative determination (step S100: Yes) is made in step S100. If an affirmative determination is made by the control unit 11 in step S100 (step S100: Yes), the process proceeds to step S102.

The control unit 11 determines whether a deviation between the parking space PS and the vehicle space VS is greater than or equal to a predetermined deviation (step S102). If a negative determination is made in step S102 (step S102: No), this routine is terminated. If an affirmative determination is made in step S102 (step S102: Yes), the process proceeds to step S104.

In step S104, the control unit 11 causes the display device 22 to display an indication representing a suggestion for re-parking overlaid on the surrounding video V (step S104). As a result of the processing of step S104, for example, the display screen 30A illustrated in FIG. 6 is displayed on the display device 22.

The control unit 11 determines whether an instruction for re-parking by the occupant is received in response to the suggestion for re-parking represented by the display M1 (step S106). For example, in the case where the control unit 11 receives a predetermined operation instructing execution of re-parking by an operation of the operation device 20 by the occupant, the control unit 11 determines that the instruction for re-parking is received. The predetermined operation is, for example, a pressing operation on a button image region representing an execution instruction displayed on the display device 22.

If a negative determination is made in step S106 (step S106: No), this routine is terminated. If an affirmative determination is made in step S106 (step S106: Yes), the process proceeds to step S108.

In step S108, the control unit 11 causes the display device 22 to display the stop position in the reciprocating positional adjustment operation TP overlaid on the surrounding video V acquired by the camera 16 (step S108). As a result of the processing of step S108, for example, any one of the display screens 30 illustrated in FIGS. 8A to 8D is displayed on the display device 22.

Then, in the case where the vehicle 1 moves forward toward the stop position in the reciprocating positional adjustment operation TP by the occupant's driving or by autonomous traveling (step S110), the control unit 11 determines whether detection of the detected parking space DS and generation of a re-parking route to the detected parking space DS are available (step S112).

Specifically, the control unit 11 detects the parking space PS as the detected parking space DS under the predetermined condition, based on the surrounding video V acquired by the camera 16, before the vehicle 1, which is moving forward, reaches the stop position in the reciprocating positional adjustment operation TP (see FIGS. 9A to 9D). The predetermined condition may be, as described above, the case where the control unit 11 detects at least one of a length of the first side s1 of the parking space PS and a length of the second side s2 opposite to the first side s1 to be greater than or equal to a predetermined length. Further, the predetermined condition may be the case where, as also described above, the control unit 11 detects at least one of the length of the first side s1 of the parking space PS and the length of the second side s2 opposite to the first side s1 to be greater than or equal to a predetermined length, and a route to the detected parking space DS can be generated.

Then, in a case where the control unit 11 detects the detected parking space DS, that is, the detected parking space DS obtained by correcting the vehicle space VS of the vehicle 1 at the time of parking in step S100, the control unit 11 generates, based on the surrounding video V acquired by the camera 16 and the like, a re-parking route for autonomous traveling leading to the detected parking space DS.

If a negative determination is made by the control unit 11 in step S112 (step S112: No), the process returns to step S110. If an affirmative determination is made in step S112 (step S112: Yes), the process proceeds to step S114.

In step S114, the vehicle 1 determines whether the re-parking route generated in step S112 involves three strokes or more (step S114).

The stroke represents the number of partial routes delimited by the reciprocating positional adjustment steering operation of the vehicle 1. Specifically, a re-parking route being one stroke represents traveling from the stopping position to the detected parking space DS without performing the reciprocating positional adjustment steering operation of the vehicle 1. The re-parking route being two strokes represents traveling from the stopping position to the detected parking space DS by one reciprocating positional adjustment steering operation. The re-parking route being three strokes or more represents traveling from the stopping position to the detected parking space DS by two or more reciprocating positional adjustment steering operations.

If an affirmative determination is made by the control unit 11 in step S114 (step S114: Yes), the process proceeds to step S116.

In step S116, in a case where the shift is changed to reverse by an operation of the shift lever included in the operation device 20, the control unit 11 notifies the possibility of re-parking in three strokes or more (step S116). For example, in a case where the shift is changed to reverse by an operation of the shift lever included in the operation device 20, the control unit 11 causes the display device 22 to display an indication representing the possibility of re-parking in three strokes or more, overlaid on the surrounding video V.

The control unit 11 receives an instruction for reverse movement when the shift is changed to reverse (R) by an operation of the shift lever included in the operation device 20 (step S118). Subsequently, the control unit 11 initiates the reverse movement by autonomous traveling of the vehicle 1 by controlling at least acceleration/deceleration and steering to cause the vehicle 1 to reverse (step S120).

In a case where the vehicle 1 reaches a position where reciprocating positional adjustment steering operation is to be performed, which is included in the re-parking route of three strokes or more (step S122), the control unit 11 returns to step S108.

On the other hand, if a negative determination is made in step S114 (step S114: No), the process proceeds to step S124.

In step S124, the possibility of re-parking is notified when the shift is changed to reverse by an operation of the shift lever included in the operation device 20 (step S124). For example, when the shift is changed to reverse by an operation of the shift lever included in the operation device 20, the control unit 11 causes the display device 22 to display an indication representing the possibility of re-parking, overlaid on the surrounding video V.

The control unit 11 receives an instruction for reverse movement when the shift is changed to reverse (R) by an operation of the shift lever included in the operation device 20 (step S126). Subsequently, the control unit 11 initiates reverse movement of the vehicle 1 by autonomous traveling by controlling at least acceleration/deceleration and steering to cause the vehicle 1 to reverse to park the vehicle 1 in the detected parking space DS by autonomous traveling (step S128). Then, this routine is terminated.

As described above, the vehicle control apparatus 10 according to the present embodiment is the vehicle control apparatus 10 mounted on the vehicle 1 provided with the operation device 20 that receives an operation by an occupant, the camera 16 that acquires the surrounding video V, the display device 22 that is visible to the occupant, and the movement control device 12 that controls at least acceleration/deceleration and steering. In the case where at least a part of the vehicle 1 is located inside the parking space PS and the operation device 20 receives an instruction for re-parking, the vehicle control apparatus 10 causes the display device 22 to display the stop position in the reciprocating positional adjustment operation TP overlaid on the surrounding video V acquired by the camera 16. In a case where the vehicle 1 moves forward toward the stop position in the reciprocating positional adjustment operation TP and, before the vehicle 1 reaches the stop position in the reciprocating positional adjustment operation TP, the parking space PS is detected as the detected parking space DS under the predetermined condition based on the surrounding video V acquired by the camera 16, the vehicle control apparatus 10 causes the display device 22 to display an indication prompting reverse movement. Subsequently, in a case where the operation device 20 receives the instruction for reverse movement, the vehicle control apparatus 10 controls at least acceleration/deceleration and steering to cause the vehicle to reverse to park the vehicle 1 in the detected parking space DS by autonomous traveling.

Thus, according to the present embodiment, in a case where at least a part of the vehicle 1 is located inside the parking space PS and the operation device 20 receives an instruction for re-parking, the vehicle control apparatus 10 causes the display device 22 to display the stop position in the reciprocating positional adjustment operation TP overlaid on the surrounding video V, and in a case where the parking space PS is detected as the detected parking space DS under the predetermined condition before the vehicle 1 moves forward toward the stop position in the reciprocating positional adjustment operation TP and reaches the stop position in the reciprocating positional adjustment operation TP, the vehicle control apparatus 10 causes the display device 22 to display an indication prompting reverse movement. Thus, the vehicle control apparatus 10, in a case where the operation device 20 receives an instruction for reverse movement, controls at least acceleration/deceleration and steering to cause the vehicle 1 to reverse to park the vehicle 1 in the detected parking space DS by autonomous traveling.

Thus, in the vehicle control apparatus 10 according to the present embodiment, it is possible to suitably assist the re-parking of the vehicle 1 for which parking is completed.

Accordingly, in the vehicle control apparatus 10 according to the present embodiment, it is possible to provide suitable parking assistance.

The hardware configuration of the vehicle control apparatus 10 according to the present embodiment is now described.

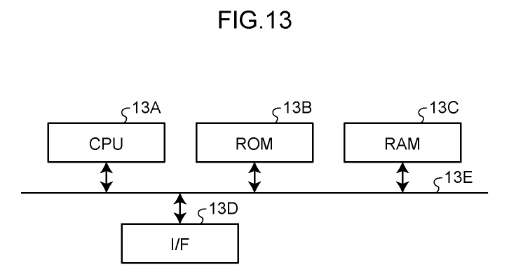

FIG. 13 is a block diagram illustrating an exemplary hardware configuration of the vehicle control apparatus 10.

In the vehicle control apparatus 10, a central processing unit (CPU) 13A, a read-only memory (ROM) 13B, a random-access memory (RAM) 13C, and an I/F 13D for connection to various devices are interconnected by a bus 13E, thereby forming a hardware configuration using an ordinary computer.

The CPU 13A is a computing device that controls overall processing of the vehicle control apparatus 10. The RAM 13C stores data necessary for various processing performed by the CPU 13A. The ROM 13B stores programs and the like for implementing various processing performed by the CPU 13A. The I/F 13D is an interface for connecting to external devices and external terminals via a communication line or the like and for transmitting and receiving data to and from the connected external devices and external terminals.

The programs for executing the various processing described above executed by the vehicle control apparatus 10 are provided pre-installed in the ROM 13B or the like. The program for executing the vehicle control method implemented in the present embodiment may be recorded, in a file of a format installable on or executable by these devices, on a computer-readable recording medium such as a CD-ROM, a flexible disk (FD), a CD-R, or a digital versatile disc (DVD), and provided thereon.

Further, the program for executing the vehicle control method implemented in the present embodiment may be stored on a computer connected to a network such as the Internet and provided by being downloaded via the network. Additionally, the program for executing the vehicle control method implemented in the present embodiment may also be provided or distributed via a network such as the Internet.

According to the vehicle control method and the vehicle control apparatus according to the present disclosure, suitable parking assistance can be provided.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A vehicle control method executed by a vehicle control apparatus mounted on a vehicle comprising: an operation device configured to receive an operation by an occupant, a camera configured to acquire a surrounding video; a display device viewable to the occupant; and a movement control device configured to control at least acceleration/deceleration and steering, the vehicle control method comprising:
causing the display device to display a stop position in a reciprocating positional adjustment operation overlaid on the surrounding video acquired by the camera in a case where at least a part of the vehicle is located inside a parking space and the operation device receives an instruction for re-parking;
the vehicle moving forward toward the stop position in the reciprocating positional adjustment operation;
causing the display device to display an indication prompting reverse movement in a case where the parking space is detected as a detected parking space under a predetermined condition based on the surrounding video acquired by the camera before the vehicle reaches the stop position in the reciprocating positional adjustment operation; and
subsequently, controlling at least acceleration/deceleration and steering to reverse the vehicle to park the vehicle in the detected parking space by autonomous traveling in a case where the operation device receives an instruction for reverse movement.

2. The vehicle control method according to claim 1,
wherein forward movement of the vehicle toward the stop position in the reciprocating positional adjustment operation is executed according to an operation performed by the occupant on the operation device.

3. The vehicle control method according to claim 1,
wherein forward movement of the vehicle toward the stop position in the reciprocating positional adjustment operation is executed by causing the movement control device to control at least acceleration/deceleration and steering.

4. The vehicle control method according to claim 1,
wherein the display device is caused to display the indication prompting the reverse movement overlaid on the surrounding video acquired by the camera.

5. The vehicle control method according to claim 1, further comprising
causing the display device to display the detected parking space overlaid on the surrounding video acquired by the camera while causing the display device to display the indication prompting the reverse movement in a case where the parking space is detected as the detected parking space under a predetermined condition based on the surrounding video acquired by the camera before the vehicle reaches the stop position in the reciprocating positional adjustment operation.

6. The vehicle control method according to claim 1,
wherein the display device comprises at least a first display unit and a second display unit.

7. The vehicle control method according to claim 1,
wherein the camera comprises at least a rear camera configured to capture the rear of the vehicle.

8. The vehicle control method according to claim 1,
wherein the case where the parking space is detected as the detected parking space under the predetermined condition is
a case where at least one of a first length of a first side of the parking space and a second length of a second side opposite to the first side is detected to be greater than or equal to a predetermined length.

9. The vehicle control method according to claim 1,
wherein the case where the parking space is detected as the detected parking space under the predetermined condition is
a case where at least one of a first length of a first side of the parking space and a second length of a second side opposite to the first side is detected to be greater than or equal to a predetermined length, and
a route to the detected parking space has been successfully generated.

10. The vehicle control method according to claim 1, wherein
the operation device comprises: at least a forward/reverse movement operation unit configured to switch between forward movement and reverse movement; and a brake operation unit configured to operate a brake configured to reduce a speed of the vehicle, and
the instruction for the reverse movement received by the operation device is
the forward/reverse movement operation unit being switched to reverse movement after the vehicle is stopped, and thereafter the brake operation unit receiving an operation to release the brake.

11. A vehicle control apparatus mounted on a vehicle comprising: an operation device configured to receive an operation by an occupant; a camera configured to acquire a surrounding video; a display device visible to the occupant; and a movement control device configured to control at least acceleration/deceleration and steering,
the vehicle control apparatus being configured to:
cause the display device to display a stop position in a reciprocating positional adjustment operation overlaid on the surrounding video acquired by the camera in a case where at least a part of the vehicle is located inside a parking space and the operation device receives an instruction for re-parking;
the vehicle moving forward toward the stop position in the reciprocating positional adjustment operation;
cause the display device to display an indication prompting reverse movement in a case where the parking space is detected as a detected parking space under a predetermined condition based on the surrounding video acquired by the camera before the vehicle reaches the stop position in the reciprocating positional adjustment operation; and
subsequently, control at least acceleration/deceleration and steering to reverse the vehicle to park the vehicle in the detected parking space by autonomous traveling in a case where the operation device receives an instruction for reverse movement.

12. The vehicle control apparatus according to claim 11,
wherein forward movement of the vehicle toward the stop position in the reciprocating positional adjustment operation is executed according to an operation performed by the occupant on the operation device.

13. The vehicle control apparatus according to claim 11,
wherein forward movement of the vehicle toward the stop position in the reciprocating positional adjustment operation is executed by causing the movement control device to control at least acceleration/deceleration and steering.

14. The vehicle control apparatus according to claim 11,
wherein the vehicle control apparatus is configured to cause the display device to display the indication prompting reverse movement overlaid on the surrounding video acquired by the camera.

15. The vehicle control apparatus according to claim 11,
wherein the vehicle control apparatus is further configured to cause the display device to display the detected parking space overlaid on the surrounding video acquired by the camera while causing the display device to display the indication prompting the reverse movement in a case where the parking space is detected as the detected parking space under a predetermined condition based on the surrounding video acquired by the camera before the vehicle reaches the stop position in the reciprocating positional adjustment operation.

16. The vehicle control apparatus according to claim 11,
wherein the display device comprises at least a first display unit and a second display unit.

17. The vehicle control apparatus according to claim 11,
wherein the camera comprises at least a rear camera configured to capture the rear of the vehicle.

18. The vehicle control apparatus according to claim 11,
wherein the case where the parking space is detected as the detected parking space under the predetermined condition is
a case where at least one of a first length of a first side of the parking space and a second length of a second side opposite to the first side is detected to be greater than or equal to a predetermined length.

19. The vehicle control apparatus according to claim 11,
wherein the case where the parking space is detected as the detected parking space under the predetermined condition is
a case where at least one of a first length of a first side of the parking space and a second length of a second side opposite to the first side is detected to be greater than or equal to a predetermined length, and
a route to the detected parking space has been successfully generated.

20. The vehicle control apparatus according to claim 11, wherein
the operation device comprises: at least a forward/reverse movement operation unit configured to switch between forward movement and reverse movement; and a brake operation unit configured to operate a brake configured to reduce a speed of the vehicle; and
the instruction for the reverse movement received by the operation device is
the forward/reverse movement operation unit being switched to reverse movement after the vehicle is stopped, and thereafter the brake operation unit receiving an operation to release the brake.
